(19) United States
(12) Patent Application Publication
(10) Pub. No.: US 2026/0087310 A1
(43) Pub. Date: Mar. 26, 2026

(54) NARRATEXPLAIN: ENHANCING EXPLAINABILITY WITH ADVANCED LLM INSIGHTS

(71) Applicant: Oracle International Corporation, Redwood Shores, CA (US)

(72) Inventors: Ali Seyfi, Vancouver (CA); Zahra Zohrevand, Vancouver (CA); Hesam Fathi Moghadam, Sunnyvale, CA (US); Rhicheek Patra, Zurich (CH); Hassan Chafi, Zurich (CH)

(21) Appl. No.: 18/897,913

(22) Filed: Sep. 26, 2024

(51) Int. Cl. G06N 3/045

(52) U.S. Cl. CPC G06N 3/045

(57) ABSTRACT

For generation and iterative improvement of an original global explanation of a machine learning model, here is refinement of a linguistic prompt. For each technical requirement, a respective reviewer large language model (LLM) may detect inaccuracies in a global explanation that characterizes a machine learning (ML) model. Based on the detected inaccuracies, a linguistic prompt that contains the global explanation is generated. From the linguistic prompt, corrective natural language (NL) that describes how the global explanation is inaccurate is inferentially generated by a critic LLM. In each iteration of a feedback loop, the corrective NL is feedback from which an explainer LLM generatively infers a revised global explanation for the ML model, and this revised explanation is more or less monotonically more accurate than the original global explanation.

### FIELD OF THE INVENTION

For generation and iterative improvement of a global explanation of a machine learning model, here is refinement of a linguistic prompt.

### BACKGROUND

In a world where machine learning (ML) models are increasingly integral to various industries, there is a pressing demand by non-technical stakeholders for generated explanations of what did a machine learn. State of the art methods of explaining model behavior often rely on technical jargon or overly simplified summaries, and these distortions can lead to misunderstandings or mistrust. There are very limited works to address this problem. Most ML explainability (MLX) approaches do not entail natural language (NL) generation (NLG). State of the art NLG MLX cannot be applied to an opaque (i.e. black box) ML model and is not agnostic to model function (e.g. classification or regression).

The state of the art lacks creativity needed to handle new patterns in ML explanations that did not occur during model training. Furthermore, in the presence of high-dimensional data, the state of the art generates excessively long and repetitive lists of points, which are not user-friendly. The state of the art has no systematic approach to aggregate features into groups, mention their impacts, ignore negligible attributions, or make feature names more appropriate.

Herein, bidirectional encoder representations for transformers (BERT) and generative pretrained transformer (GPT) are interchangeable or equivalent opensource implementations of a general-purpose LLM that is a pretrained deep neural network (DNN) for natural language (NL) processing (NLP). An LLM is a powerful language model that may rely heavily on the structure and patterns of NL to understand and process meaningful text. Diction and phrasing, being the arrangement of words and phrases in a sentence, significantly affect an LLM's accuracy for the following reasons.

An LLM's contextual comprehension may be affected by semantics such as dependency relationships between words in an NL prompt that the LLM accepts as input. The LLM learns how words relate to each other syntactically, which aids in comprehension of the overall meaning of a sentence. For example, recognizing a subject-verb-object structure helps the LLM infer causes and effects. Syntactic information provides structural clues that help the LLM disambiguate words with multiple meanings by considering the context in which a word is used.

The accuracy of an NL prompt may be measured by measuring the accuracy of an inference from the prompt. That is, natural language may be measurably inaccurate. For example, the accuracy of generated NL is measurable.

The following are supervised (i.e. labeled) and unsupervised ways of measuring accuracy of generated NL. With a labeled dataset, it is possible to measure NL accuracy quantitatively with the following various NL metrics, including metrics similar to Factuality that measures how much of the generated NL is relevant (i.e. signal, not noise). The following are automatic ways to measure accuracy of prose.

Bilingual Evaluation Understudy (BLEU) has a scale from 0 to 1 where 0 corresponds to complete inaccuracy and 1 to perfect accuracy. The score is calculated based on the number of matching n-grams (multiword short phrases) using a modified n-gram precision and a brevity penalty to prevent biases.

Recall-Oriented Understudy for Gisting Evaluation (ROUGE) is a set of metrics for comparing the desired output and the reference. It measures the longest matching sequence of words in the two texts.

MPNet measures similarity between two pieces of text as cosine similarity of embedding vectors that represent the text.

The AlignScore metric uses a tuned Robustly Optimized BERT Pretraining Approach (ROBERTa) and a function on the output of the model to output a score between 0 and 1 representing the alignment of two strings of text. This approach is different from the others because it uses an LLM. It uses the embeddings (a compressed representation of the sentence) given as output from the ROBERTa language model.

By the above example accuracy metrics, accuracy of any NL generated herein may be quantified, and this accuracy is a performance measurement of an LLM that generated the NL and a performance measurement of internal operation of a computer that hosts the LLM.

### BRIEF DESCRIPTION OF THE DRAWINGS

In the drawings:

FIG. 1 is a block diagram that depicts an example computer that generates and iteratively improves a global explanation of a machine learning (ML) model by refinement of a linguistic prompt;

In respective ways, FIG. 2 has two flow diagrams that depict a same computer process that generates and iteratively improves a global explanation of a ML model by refinement of a linguistic prompt;

FIG. 3 is a flow diagram that depicts a computer process of a final iteration that generates a current NL global explanation that is: a) more accurate than the previous best NL global explanation and b) accurate enough to return to the user;

FIG. 4 is a block diagram that illustrates a computer system upon which an embodiment of the invention may be implemented;

FIG. 5 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

For generation and iterative improvement of a global explanation of a Machine Learning (ML) model, here is refinement of a linguistic prompt. This approach is an innovative way to convert outcomes of ML Explainability (MLX) methods, such as explainable artificial intelligence (XAI), into comprehensible natural language (NL) explanatory narratives. This approach goes beyond simple translation and harnesses the power of large language models (LLMs) to produce insightful explanations, incorporating knowledge from additional sources like training data to enrich and verify the narrative. By doing so, this approach strives to demystify the intricate workings and predictions of complex models, making them accessible to non-technical audiences. The goal is to close the communication gap between sophisticated technical outputs and users without a technical background, thereby increasing transparency and interpretability within the realm of ML applications.

This approach is an innovative system designed to address the challenge of translating complex (e.g. quantitative) ML model explainability results into easily understandable NL explanations. This is achieved by leveraging LLMs to craft coherent and informative explanatory narratives. The system begins by fitting an ML model on input data and then, for example using Oracle AutoMLx explainability package, generates explainability results. These results, along with the input data are persisted into a knowledge source such as a filesystem or a database.

This approach leverages interactions and communications between LLMs in diverse roles. The goal of this approach is to produce a more intelligible explanation by actively working to minimize the risks of hallucinations and the omission of critical information.

This approach takes advantage of available data sources for the following two purposes. One purpose is to finetune the prompts passed to an Explainer Agent that performs NL generation (NLG). Another purpose is to let the Explainer agent utilize knowledge sourced from input datasets, along with explainability results and NL explanation examples, to craft comprehensive NL explanations. This method ensures that insights from the input dataset are seamlessly integrated with the explanations, enhancing the relevance and accuracy of the generated narratives.

To complete a feedback loop of communication, the generated NL explanations undergo further scrutiny by a review committee, where several reviewer agents review the quality of the generated explanation. These reviews focus on detecting hallucinations, overlooked insights, inconsistencies, or any other potential issues within the explanations.

Subsequently, a critic agent acts as a mediator and evaluates the reports produced by the reviewer agents. If an explanation satisfies a quality threshold or termination rule(s), the explanation is finalized as the final NL explanation that may, for example, be persisted or provided to a user. Conversely, if the explanation is inadequate (i.e. inaccurate), feedback is generated and directed back to the Explainer agent for refinement. This feedback loop more or less monotonically increases the quality of the latest explanation with each iteration.

This approach includes the following innovations. This approach harnesses the power of LLMs to craft detailed and cohesive narratives, setting a new standard for explanation clarity and depth. Each agent within this framework can be powered by a distinct respective LLM that is tailored to a distinct respective specific task and technical requirement.

This approach has an iterative feedback loop involving a sequence of three types of LLM agents: Generator, Reviewers, and Critic. This approach ensures continuous improvement in the quality of LLM output. Specialized Reviewer Agents focus on specific tasks to improve the quality of reviews and provide precise, targeted explanations. Reviewers evaluate the content for accuracy and relevance, ensuring that each review meets required standards.

The critic agent acts as an arbiter, synthesizing input from multiple reviewer agents. This entails assessing the generator's results and reviewer comments to decide whether an explanation needs further revision or instead is ready for user exposure. This ensures a consistent and high-quality (i.e. accurate) output, serving as a quality control mechanism beyond the capability of any individual review.

This approach employs template-based prompts to standardize the explanation process. These templates ensure consistency and meet diverse user requirements by combining a structured approach with adaptability to address specific contexts, achieving an optimal balance between creativity, clarity, and efficiency. These templates are both domain-agnostic and model-agnostic, making them versatile and applicable across various fields and models.

This approach may prioritize reviews and apply them sequentially (i.e. one by one). This strategy helps the generator improve its results incrementally by focusing on clear, actionable feedback. The system adopts a Retrieval-Augmented Generation (RAG) strategy, utilizing comprehensive data sources, including input data, ML explainability outcomes, and NL explanation examples. This approach enriches explanations with data-driven insights, ensuring they accurately reflect data patterns and model behaviors, thereby boosting interpretability. Furthermore, this approach supports the incorporation of references for post-hoc verification, enhancing the overall trustworthiness and validity of the generated explanations and minimizing inaccuracies in the narrative within each explanation.

This approach has the following unconventional advantages. This approach enhances clarity for complex ML models by providing NL explanations that are easily understood, thereby advancing transparency and interpretability. This empowers nontechnical stakeholders to make more informed decisions due to improved interpretability, because an NL explanation effectively is a translation of technical model outputs into layperson-friendly prose.

This approach utilizes the evolving capabilities of LLMs to continuously refine and improve the quality of NL explanations, ensuring relevance and precision in light of data and insights. This has the potential to enhance trust in artificial intelligence (AI) systems by delivering clear and accurate explanations for model predictions and behaviors, contributing to a deeper comprehension and heightened transparency.

Overall, this approach is designed to reduce the risk of inaccuracies and omissions in the explanations provided, striving to improve explanation understandability, accuracy, and dependability. With design goals of iterative explanation improvement and stringent evaluation, this approach plays an important role in fostering greater transparency and trust in AI applications.

This approach is especially robust as follows. It is possible that some review feedback might be vague and thus the explainer agent is not able to address it. The following technique can help in such conditions. Employing specialized reviewers mitigates the chance of providing vague feedback. Each reviewer focuses on specific evaluation criterion(s), enabling them to provide clearer and more precise feedback.

In an embodiment, reviewers are dynamically tuned to provide clear and specific feedback that is To-the-Point by detailing exactly what is lacking or incorrect in the explanation. Template-Based and Few-Shot Learning may be used as follows. To clarify (i.e. explicate and impose) correctness expectations in an embodiment, reviewers include examples in their feedback or utilize few-shot learning techniques. This helps the explainer agent understand the feedback better and make the necessary adjustments. Additionally, using predefined templates for review tasks helps reviewers produce more structured feedback.

Using templates and structured prompts to optimize interactions with LLMs is a design strategy that aims to improve the effectiveness of prompts for enhanced explainability. This approach employs LLMs for data analysis, particularly by implementing specific conditions designed to limit hallucinations in model responses. By incorporating these unconventional safeguards, this approach ensures that the generated explanations are not only more accessible to a wider audience but also accurate and reliable, thereby addressing a critical challenge in the use of LLMs for Explainable AI (XAI).

This approach facilitates Automated Data Exploration with LLMs. State of the art use of LLMs in automating data exploration is not focused on the concept of interpretability.

This approach achieves Reasoning and Criticism based Prompting, which encourages the LLMs to reflect on their own reasoning processes. This is achieved through techniques such as chain-of-thought prompting to guide the LLM to consider the steps leading to its output, thereby improving the final result or the generation process itself.

This approach achieves criticism-based prompting, which involves introducing a separate critic agent that contains another LLM. This critic analyzes the output of the generator LLM, identifies potential issues, and helps the generator refine its work. Herein, a feedback loop incorporates three key components: 1) the Generator, 2) Reviewers, and 3) the Critic. In this design, specialized reviewers evaluate the results from various perspectives, ensuring comprehensive feedback. The critic acts as a referee in the dialogue between the generator and the reviewers, ensuring a productive exchange. The critic LLM facilitates a more effective (i.e. fast and accurate) learning environment for the generator LLM, enhancing the overall quality and interpretability of the generated outputs.

### 1.0 Example Computer

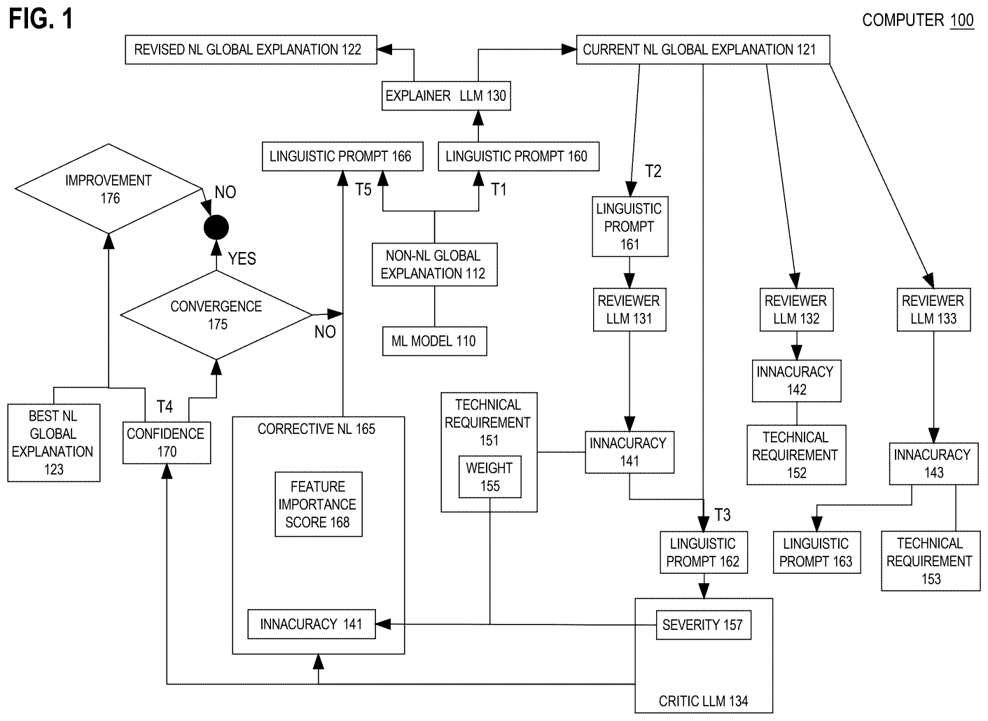

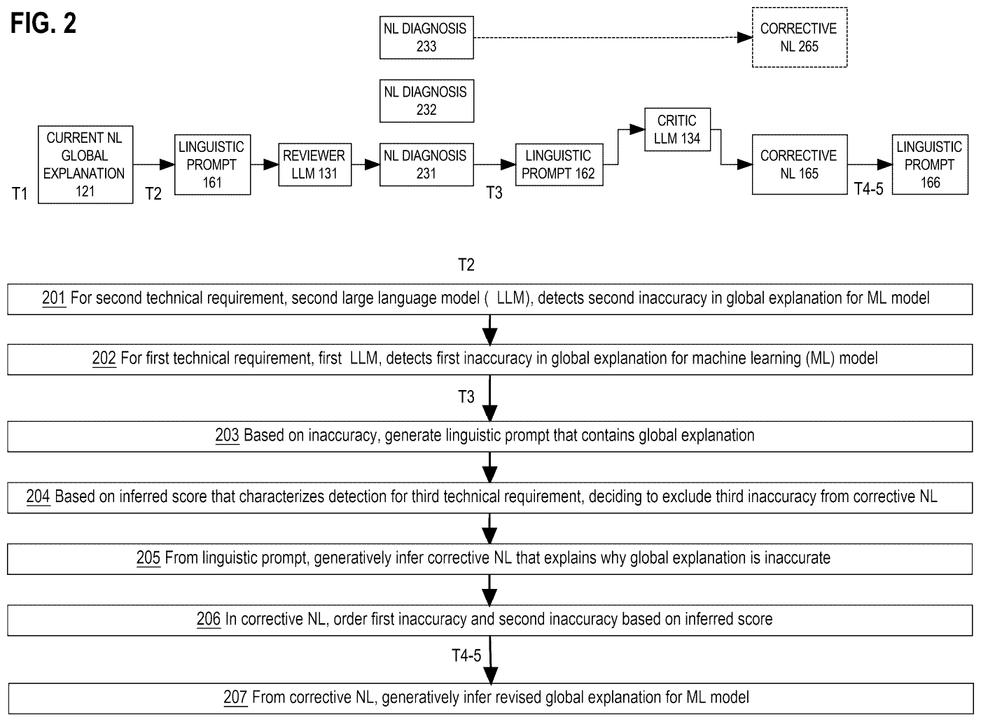

FIG. 1 is a block diagram that depicts an example computer 100 that generates and iteratively improves a global explanation of machine learning (ML) model 110 by refinement of linguistic prompt 160. Computer 100 may be one or more computers such as a rack server such as a blade, a personal computer, a mainframe, or a virtual computer. All of the shown components may be respectively stored and operated in volatile or nonvolatile storage of computer 100.

ML model 110 may referred to herein as a target model. ML model 110 was already trained to perform an application-specific function. ML model 110 may have any learned function such as classification, regression, or detection. In an embodiment, ML model 110 is opaque (i.e. black box). For example, a user of computer 100 might not know what is the architecture of ML model 110 and how can ML model 110 be retrained. In an embodiment, computer 100 does not contain or access ML model 110. For example, the approach herein succeeds even if ML model 110 no longer exists.

### 1.1 Original Natural Language (NL) Global Explanation and Non-NL Global Explanation

The purpose of computer 100 is to inferentially generate best natural language (NL) global explanation 123 as a most accurate and most comprehensible prose (i.e. NL, e.g. natural sentences) that explains of how ML model 110 generally reacts to inputs. As discussed later herein, explainer large language model (LLM) 130 generates a sequence of alternative distinct NL global explanations 121-123 that explain same ML model 110.

Even if computer 100 lacks ML model 110, computer 100 has non-NL global explanation 112 that explains ML model 110. Non-NL global explanation 112 does not contain NL. Depending on the embodiment, non-NL global explanation 112 may be a ranking as a list of features sorted by measured importance or may be a feature importance table that contains pairs of a distinct feature and the feature's feature importance (a.k.a. attribution). Feature importance is numeric and may be referred to herein as a feature importance score or a feature attribution score. Non-NL global explanation 112 may be the following example feature importance table. Because this example feature importance table is sorted by attribution score, this example feature importance table may also be used as a ranking of features by importance.

| | feature | attribution |
|---|---|---|
| 0 | sex | 0.226855 |
| 1 | pclass | 0.122427 |
| 2 | age | 0.0403503 |
| 3 | fare | 0.0247217 |

Herein, all feature importances originate in non-NL global explanation 112. For example as discussed later herein, feature importance score 168 in corrective NL 165 is propagated from non-NL global explanation 112. In an embodiment, computer 100 uses perturbation feature importance (PFI), SHAP, LIME, or other attribute-based explanation (ABX) technique to generate non-NL global explanation 112. Non-NL global explanation 112 may be more or less incomprehensible to a user for understanding how ML model 110 generally reacts to inputs. For example, non-NL global explanation 112 might not be presented to the user.

### 1.2 Original Linguistic Prompt Causes NL Generation (NLG) by Explainer Large Language Model (LLM)

Operation of computer 100 proceeds as an ordered sequence of shown steps T1-T5 as follows. All operation of ML model 110 occurs before T1. For example, ML model 110 might no longer exist when step T1 begins. Step T1 operates as follows. Step T1 receives or generates non-NL global explanation 112 as discussed above.

Step T1 generates linguistic prompt 160 that is NL (i.e. text) that contains non-NL global explanation 112 formatted as text (e.g. NL or not). Generation of any of linguistic prompts 160-161 and 166 may entail dynamically inserting values into placeholders in a distinct respective prompt template that is text that contains NL. A placeholder is delimited by a pair of enclosing curly braces. In the following example linguistic prompt 160, step T1 encodes non-NL global explanation 112 as text and replaces placeholder ml_explanation with that text.
[INST] Translate the machine learning (ML) model explanation, presented in a DataFrame, into a natural language summary. The explanation data is as follows: {ml explanation} Context:
   The explanation is derived from a Perturbation-Based Feature Importance (PBFI) analysis.
   Higher values in the data indicate a stronger impact on the model's predictions. Positive values suggest a positive influence on the outcome.
   ‘lower bound’ and ‘upper bound’ refer to the confidence interval for the feature importance values listed in the ‘attribution’ column.
Objective:
Create human-readable explanations to help users understand how the ML model makes predictions based on feature importance, avoiding the need for direct interpretation of the DataFrame. [/INST]

Each of linguistic prompts 160-163 and 166 is NL that may, for example, be tokenized into a sequence of lexical tokens (e.g. natural words). Generative NL processing (NLP) is referred to herein as NL generation (NLG). LLMs 130-134 each performs respective one or a few NLG functions that each is a specialization of a respective general kind of NLG function.

Herein, a prosaic function is a general NLG function that primarily or exclusively generates prose (i.e. NL, e.g. a natural sentence or natural paragraph). A prosaic function may be referred to herein as an NL-to-NL function. LLMs 130-134 each performs a distinct respective prosaic function as discussed later herein.

In step T1, explainer large language model (LLM) 130 accepts linguistic prompt 160 as input, which causes explainer LLM 130 to perform NLG that inferentially generates current NL global explanation 121 that is prose that explains how ML model 110 generally reacts to inputs. Herein, explainer LLM 130 may also be referred to as a generator LLM because it generates NL global explanations 121-123. The following is an example current NL global explanation 121.
The model uses several factors to predict the target variable. The least important feature is ‘sex’, with an attribution value of 0.226855, indicating that gender has a negligible influence on the outcome. The most important feature is ‘fare’, contributing significantly with an attribution of 0.0247217, suggesting that how much a passenger paid for their ticket is the primary factor. ‘Pclass’ has a minor effect on the prediction, with an attribution of 0.122427, meaning the class of the passenger is relatively unimportant. Finally, ‘age’ is the second most important feature with an attribution value of 0.0403503, indicating that
the age of the passenger plays a major role in the model's predictions.

### 1.3 Review Committee Contains Multiple LLMS, Each Distinctly Specialized for Respective Technical Requirement

Step T2 inspects current NL global explanation 121 for defects (i.e. inaccuracies) as follows. Each of reviewer LLMs 131-133 was already trained to enforce (i.e. detect noncompliance) of a respective one of technical requirements 151-153. Each of technical requirements 151-153 is a distinct linguistic requirement that is a distinct way that an NL global explanation may be defective.

An embodiment may implement some or all of the following example technical requirements in the following table 1.

| Technical Requirement | Description |
|---|---|
| Coherence (also referred to herein as semantic | The explanation should logically flow and be |
| coherence) | easy to follow, ensuring that the reasoning |
| | behind the feature importance is clear. |
| Consistency (also referred to herein as factual | The explanation should consistently align |
| consistency) | with the data and the model's behavior. |
| Clarity (also referred to herein as syntactic | The explanation should be written in clear and |
| ambiguity when lacking) | simple language. |
| Correctness of Interpretation | The explanation should accurately reflect the |
| | model's attributions and not mispresent the |
| | feature importances. |
| Fidelity | The explanation should be faithful to the ML |
| | explanations, ensuring there is no deviation or |
| | distortion. |
| Relevance (also referred to herein as semantic | The explanation should focus on the most |
| relevance) | relevant features and not include irrelevant |
| | information that could distract the reader. |
| Contextual Accuracy | The explanation should correctly interpret the |
| | feature importance within the specific context |
| | of the model and the data. |
| Comprehensiveness (also referred to herein as | The explanation should cover all important |
| semantic ambiguity when lacking) | aspects and provide a complete picture |
| | without leaving out critical information. |
| Traceability | The explanation should allow users to trace |
| | back the feature importance to the original |
| | data and model decisions. |
| Simplicity (also referred to herein as brevity | The explanation should aim for simplicity in |
| or, when lacking, as verbosity) | its presentation, avoiding overly complex |
| | jargon or technical details that could confuse |
| | the reader. |
| Audience Appropriateness | The explanation should be tailored to the |
| (also referred to herein as pragmatic | target audience, considering their level of |
| coherence) | expertise and familiarity with the subject |
| | matter. |

For example even if reviewer LLMs 131-133 have a same general LLM architecture, reviewer LLMs 131-133 are distinct because each was trained for a distinct task (i.e. detection of violation of a distinct technical requirement). For example, reviewer LLMs 131-133 each has a distinct set of neural connection weights. Various embodiments have a distinct respective reviewer LLM for each of some or all of the distinct technical requirements in above table 1.

In step T2, each review task (i.e. each of reviewer LLMs 131-133) accepts as input a distinct respective linguistic prompt that is dynamically generated from same current NL global explanation 121. Thus, step T2 should dynamically generate a distinct linguistic prompt respectively for each of reviewer LLMs 131-133. For example, reviewer LLM 131 accepts linguistic prompt 161 as input, which is not the same as the other linguistic prompts that step T2 (e.g. concurrently for acceleration) generates for acceptance as input by reviewer LLMs 132-133. In an example where technical requirement 151 is the above Correctness of Interpretation in table 1, then in the following example linguistic prompt 161, step T2 replaces placeholder nl_explanation with current NL global explanation 121.
[INST]
Context:
Act as a critic and evaluate the output of another LLM (1) based on an existing resource (2).
   (1) Full Natural Language Explanation for Evaluation:
   {nl_explanation}
   (2) Model explanation generated by Perturbation based explainer: {ml explanation} Output:
   Indicates whether the generated explanation (1) contains correct interpretation just based on the information from (2) Model explanation. [/INST]
      1.4 Each NL Diagnosis is a Distinct Technical Review that can Identify Inaccuracies

In step T2, reviewer LLMs 131-133 (e.g. concurrently for acceleration) inferentially generate respective NL that contains a respective one of inaccuracies 141-143 expressed as NL. Output of a reviewer LLM is a learned inference expressed as generated NL and referred to herein as a technical review or, as shown in FIG. 2, an NL diagnosis. A technical review may consist of zero or more inaccuracies for (i.e. violations of) a same one of technical requirements 151-153. For example in step T2, reviewer LLM 131 may inferentially generate a technical review that contains zero, one, or multiple inaccuracies for same technical requirement 151.

In the example where technical requirement 151 is the above Correctness of Interpretation in table 1, then as inferentially generated in step T2 by LLM 131, the following is an example technical review that contains an enumerated list that describes the following two inaccuracies.
The generated explanation (1) contains incorrect interpretations based on the information from (2) Model explanation. Specifically:
   It reverses the importance of ‘sex’ and ‘fare’, incorrectly identifying ‘sex’ as the least important and ‘fare’ as the most important feature.
   It misinterprets the importance of ‘pclass’ and ‘age’, ranking them incorrectly in terms of their contributions.
Therefore, the explanation is incorrect as it fails to accurately reflect the attribution values provided in the model explanation.

In step T3, multiple linguistic prompts are (e.g. concurrently for acceleration): dynamically generated and then accepted as separate inputs by critic LLM 134. As shown, linguistic prompts 162-163 are generated based on respective technical reviews output from respective reviewer LLMs 131 and 133. Step T3 also generates a linguistic prompt (not shown) based on a technical review output from respective reviewer LLM 132. In other words, step T3 generates three distinct linguistic prompts and, with those prompts, invokes critic LLM 134 three times. Quantitative analytic values 155 and 157 and an example linguistic prompt 162 are discussed later for FIG. 2.

### 1.5 Iteration, Convergence, Cessation, and Diagnostic Confidence of Refinement in Progress

The goal of computer 100 is to generate best NL global explanation 123. Critic LLM 134 may inferentially generate confidence 170 that may have two tuning purposes discussed later herein. Semantics (i.e. higher or lower is better) of confidence 170 may be reversed in some embodiments as follows. In an embodiment having the above example linguistic prompt 162 that says “score”: a) this score is confidence 170, b) confidence 170 is an accuracy metric that is a quantitative measurement of how accurate is current NL global explanation 121. In that case, confidence 170 is critic LLM 134's estimated likelihood that current NL global explanation 121 will be the overall (i.e. final) best NL global explanation 123 that computer 100 provides to the user.

Thresholds 175-176 individually cooperate with confidence 170 in step T4 as follows. In an embodiment with reversed confidence semantics: a) confidence 170 instead is critic LLM 134's estimated likelihood that current NL global explanation 121 is significantly inaccurate (i.e. needs refinement). In that case, confidence 170 is an error metric that is a quantitative measurement of how inaccurate is current NL global explanation 121. However herein, confidence 170 is not a loss magnitude for neural backpropagation in a multilayer perceptron. That is herein, no LLM or ML model is training because herein is use in a production environment where training is presumed finished. In other words, all models herein already were trained and may be immutable (i.e. read only, e.g. immutable neural connection weights).

Convergence 175 is a sufficiency threshold that detects whether current NL global explanation 121 is good (i.e. accurate) enough to provide to the user as the final and best NL global explanation. If confidence 170 exceeds convergence 175, then step T4 is not followed by step T5, and iterative NLG ceases as indicated by the shown dark circle above convergence 175. Otherwise, iterative NLG proceeds as follows.

Herein, iterative NLG is a way to iteratively refine (i.e. improve, increase accuracy of) current NL global explanation 121 by iteratively replacing linguistic prompt 160 with a refined (i.e. improved, more accurate) linguistic prompt 166 at step T5 as follows.

Iterative NLG entails a sequence of iterations. A distinct new current NL global explanation 121 is inferentially generated and processed each iteration as follows.

Regardless of current iteration, computer 100 retains a single best NL global explanation 123 (and its confidence 170) that is the best (i.e. most accurate) current NL global explanation 121 that was generated in any iteration so far. If threshold improvement 176 in step T4 detects that confidence 170 exceeds the confidence of best NL global explanation 123, then current NL global explanation 121 is retained as a new best NL global explanation 123, and the old best NL global explanation 123 is discarded.

For whatever reason iterative NLG ceases, best NL global explanation 123 is always available. For example, a time limit or a maximum count of iterations may be exhausted without iterative NLG generating a best NL global explanation 123 that exceeds threshold convergence 175. In other words when iterative NLG ceases, best NL global explanation 123 may be insufficient (i.e. too low accuracy). Depending on the embodiment: a) an insufficient final best NL global explanation 123 is provided to the user with a warning that indicates low confidence (e.g. presented as a best guess), or b) an insufficient final best NL global explanation 123 is discarded, and the user is instead provided a warning that ML model 110 is inexplicable.

In some cases, iteration ceases only after a sequence of multiple iterations, which means that most iterations proceed to step T5 as follows.

Step T5 generates linguistic prompt 166 that is better (i.e. more accurate) than linguistic prompt 160. In the following example linguistic prompt 166, step T5 replaces placeholder evaluation with corrective NL 165.
[INST] Context:
   You have generated following explanation for the provided explanation data: {nl_explanation}
   provided explanation data: {ml explanation}
   A critic reviewed your explanation and provided following feedback: {evaluation}
Objective:
Improve the explanation using the evaluation report. [/INST]

In step T5, linguistic prompt 166 causes explainer LLM 130 to inferentially generate, in a next NLG iteration, revised NL global explanation 122 that should be better (i.e. more accurate) than current NL global explanation 121 of the previous iteration. Regardless of whether or not revised NL global explanation 122 actually is better than current NL global explanation 121: a) revised NL global explanation 122 is retained as a new current NL global explanation 121, b) the previous current NL global explanation 121 is discarded unless already retained as best NL global explanation 123, and c) the next NLG iteration proceeds in a same way as discussed above for the previous iteration. Non-NL global explanation 112 is identical in all iterations.

### 2.0 First Example Iterative Refinement Process

The top and bottom of FIG. 2 depict separate diagrams referred to herein as the top diagram and the bottom diagram, which both depict a same process, referred to herein as the process of FIG. 2, that computer 100 may perform to generate and iteratively improve a global explanation of ML model 110 by refinement of linguistic prompt 160. The top diagram is a flow diagram that horizontally flows from left to right and begins between steps T1-2. The top diagram presumes that step T1 already occurred. The top diagram finishes during step T5.

In the top diagram during step T2, reviewer LLMs 131-133 respectively infer NL diagnoses 231-233 that contain respective inaccuracies 141-143 as discussed earlier herein. How some or all of NL diagnoses 231-233 are automatically combined depends on the embodiment as follows. In other words, the dashed outline of corrective NL 265 and the dashed horizontal arrow from NL diagnosis 233 to corrective NL 265 may represent implementation specificity, where the dashed lines may be implemented differently in two distinct embodiments of critic LLM 134 referred to herein as a multi-prompt critic embodiment and a combined-prompt critic embodiment.

In the multi-prompt critic embodiment: a) linguistic prompt 162 does not contain NL diagnosis 233, b) a separate somewhat similar linguistic prompt (not shown) is generated that contains NL diagnosis 233, and c) critic LLM 134 separately (i.e. sequentially) infers either of corrective NLs 165 or 265. In the combined-prompt critic embodiment that lacks (i.e. does not implement) a separate corrective NL 265 for NL diagnosis 233: a) NL diagnoses 231-233 are concatenated into same linguistic prompt 162, and b) each of components 165-166 regards all NL diagnoses 231-233. These two embodiments of critic LLM 134 respectively operate steps 201-206 of the process in the bottom diagram that computer 100 performs as follows.

The bottom diagram is a flow diagram that vertically flows from top to bottom. The bottom diagram begins during step T2 and finishes during step T5.

It does not matter in what relative ordering are NL diagnoses 231-233 generated or further processed, and their generation or processing may be concurrent for acceleration. Regardless of which of NL diagnoses 231-233 is generated first, NL diagnosis 233 may, for example, be a second review whose processing races ahead of processing of NL diagnosis 231 that, in this example, is a first review. In that case in step 201 for technical requirement 153, reviewer LLM 133 detects inaccuracy 143 in current NL global explanation 121 as shown in FIG. 1. Likewise in step 202 for technical requirement 151, reviewer LLM 131 detects inaccuracy 141 in current NL global explanation 121. The relative ordering of steps 201-202 depends on the example. Steps 201-202 are sub-steps of step T2.

Steps 203-206 are sub-steps of step T3 as follows. The two above embodiments of critic LLM 134 perform step 203 in distinct respective ways as follows. In the multi-prompt critic embodiment of critic LLM 134, step 203 generates separate linguistic prompts that respectively contain NL diagnosis 231 (i.e. in linguistic prompt 162) or 233 as discussed above. In the combined-prompt critic embodiment of critic LLM 134, step 203 instead generates a single linguistic prompt 162 that contains (e.g. concatenated) both NL diagnoses 231 and 233.

In the following example linguistic prompt 162 in the multi-prompt critic embodiment, step 203 replaces placeholder evaluation with only one NL diagnosis 231. In the combined-prompt critic embodiment, step 203 instead replaces placeholder evaluation with a concatenation of all NL diagnoses 231-233. The following example linguistic prompt 162 contains three distinct pronouns that are its, we, and your. Here: your means critic LLM 134; we means explainer LLM 130 supervised by critic LLM 134; and its means current NL global explanation 121.
Context:
A model's explanation has been translated into natural language and subsequently evaluated by another reviewer LLM based on its completeness relative to the original dataframe of model explanations.
Evaluation Summary: {evaluation}
Natural Language Explanation: {nl_explanation}
[INST] Given the evaluation findings provided along with the model explanations, should we revise the natural language explanation to better reflect the model explanation insights?
[/INST]
[INST] Your answer should be a number on a scale of 1 to 10 indicating the necessity of revision. A higher score means the review comment is more significant. [/INST]

Step 204 is a sub-step of step 203. Step 204 detects that NL diagnosis 232 is insignificant and should be excluded. In the combined-prompt critic embodiment in step 204, exclusion of NL diagnosis 232 entails storing NL diagnoses 231 and 233 in corrective NL 165 but not storing NL diagnosis 232 in corrective NL 165. In the multi-prompt critic embodiment in step 204, exclusion of NL diagnosis 232 entails not generating corrective NL when critic LLM 134 accepts a linguistic prompt that contains NL diagnosis 232.

In an embodiment, step 204 operates quantitative analytic values 155 and 157 to include NL diagnosis 231 and, although not shown in FIG. 1: a) technical requirements 151-153 may each have a separate respective positive numeric weight that is a manually predefined magnitude that indicates a respective relative priority (e.g. importance) of each distinct technical requirement, and b) for each of corresponding NL diagnoses 231-233, critic LLM 134 may inferentially generate a separate respective positive numeric severity that is a magnitude that indicates how extensively does current NL global explanation 121 violate, for example, technical requirement 151. In an embodiment, weight 155 is an estimated probability that a violation of technical requirement 151 would be sufficiently problematic to prevent a defective NL global explanation from remaining the final best NL global explanation 123.

In an embodiment, weight 155 is an estimated probability that a violation of technical requirement 151 would be sufficiently problematic to prevent a defective NL global explanation from remaining the final best NL global explanation 123. In an embodiment, severity 157 is directly proportional to a probability that inaccuracy 141 would be sufficiently problematic to prevent a defective NL global explanation from remaining the final best NL global explanation 123. For example, a technical review that describes two inaccuracies (e.g. two violations of technical requirement 151) has a higher (e.g. double) severity than a technical review that describes only one inaccuracy. For example, explainer LLM 130 hallucinating and identifying two nonexistent features in an NL global explanation is more severe than hallucinating only one nonexistent feature.

In step 204, critic LLM 134 may inferentially generate a multiplicative product (not shown), referred to herein as an inferred score, that is a positive number having a magnitude that indicates how significant (e.g. important) is NL diagnosis 231. For example in step 204, critic LLM 134 may inferentially detect that the inferred score of NL diagnosis 232 is below a significance threshold and, in that case, step 204 excludes (i.e. discards) NL diagnosis 232 without storing NL diagnosis 232 in any linguistic prompt.

In step 205, critic LLM 134 inferentially generates corrective NL 165 as discussed earlier herein. Steps 204-205 are both caused by acceptance of linguistic prompt 162 by critic LLM 134

Step 206 is a sub-step of step 205. In corrective NL 165, step 206 orders (i.e. sorts) inaccuracies 141 and 143 based on their respective inferred scores from step 204 as discussed earlier herein.

Step 207 is a sub-step of step T5. In step 207, explainer LLM 130 inferentially generates revised NL global explanation 122 that may, for example, be processed in more or less a same way as current NL global explanation 121. For example: a) a previous iteration may inferentially generate revised NL global explanation 122, and b) revised NL global explanation 122 may be used as current NL global explanation 121 in a next iteration.

### 3.0 Second Example Iterative Refinement Process

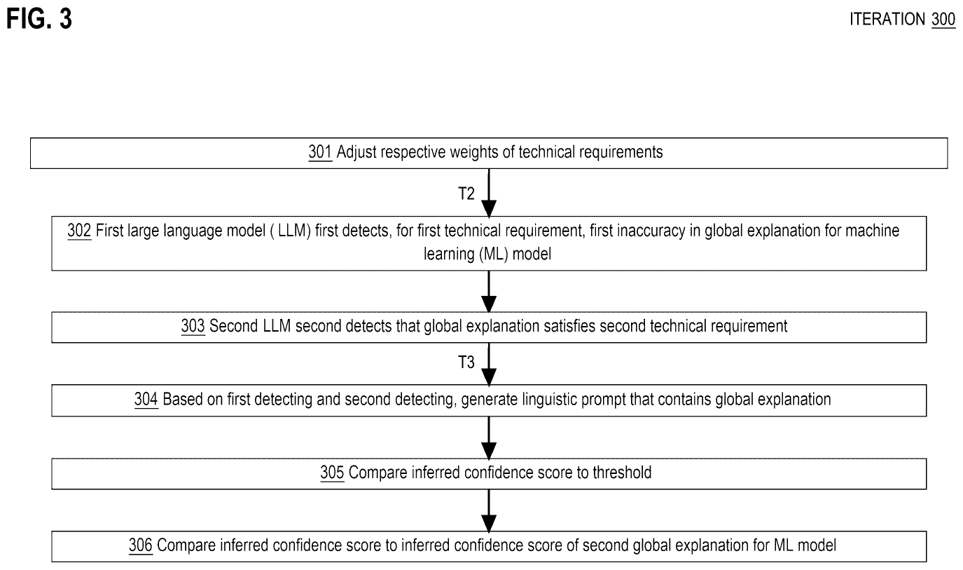

As discussed earlier herein, model explanation may entail iterative refinement, and the process of FIG. 2 may be repeated in each iteration. FIG. 3 is a flow diagram that depicts an example process that computer 100 may perform during a final iteration that generates a current NL global explanation 121 that is: a) more accurate than the previous best NL global explanation 123 and b) accurate enough to return to the user.

In an embodiment, weights of technical requirements 151-153 are dynamically tunable at runtime even though LLMs 130-134 were already trained. Between a previous iteration and a next iteration, step 301 performs: a) weight 155, for example, is increased proportional to a count of inaccuracies identified in NL diagnosis 231, and b) after increasing weight(s), the weights are unit normalized to sum to one. Step 301 may be repeated before each time a new iteration begins, except for the first iteration.

Shown as previous (e.g. not final) iteration 350, steps 302-306 may occur in each iteration as follows. Steps 302-303 are sub-steps of step T2. For technical requirement 151 in step 302, reviewer LLM 131 detects inaccuracy 141 in current NL global explanation 121.

In step 303 in this scenario, reviewer LLM 133 detects that current NL global explanation 121 satisfies technical requirement 153. In other words, reviewer LLMs 131 and 133 disagree as to whether or not current NL global explanation 121 is accurate.

Steps 304-306 are sub-steps of step T3. Step 304 generates linguistic prompt 162 from NL diagnoses 231 and 233 as discussed earlier herein.

Thresholds 175-176 operate during respective steps 305-306 as follows. Step 305 compares inferred confidence score 170 to threshold convergence 175 as discussed earlier herein. If convergence 175 is exceeded: a) current NL global explanation 121 has effectively been inferentially detected as accurate, b) iteration ceases, and b) current NL global explanation 121 is guaranteed to be more accurate than best NL global explanation 123 because best NL global explanation 123 did not exceed convergence 175.

Step 306 compares inferred confidence score 170 to the inferred confidence score of best NL global explanation 123. Step 306 may compare a subtractive difference of inferred confidence score 170 minus the inferred confidence score of best NL global explanation 123 and, if that subtractive difference does not exceed threshold improvement 176, then: a) iteration ceases, and b) to the user is returned a result that contains: i) best NL global explanation 123 and/or ii) an indication that best NL global explanation 123 is inaccurate.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

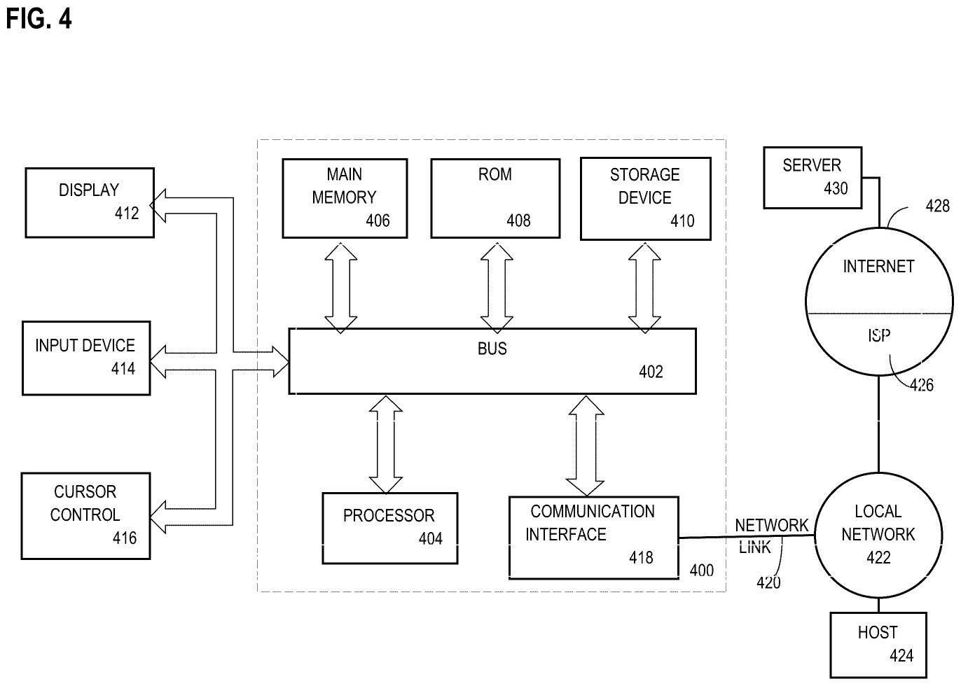

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

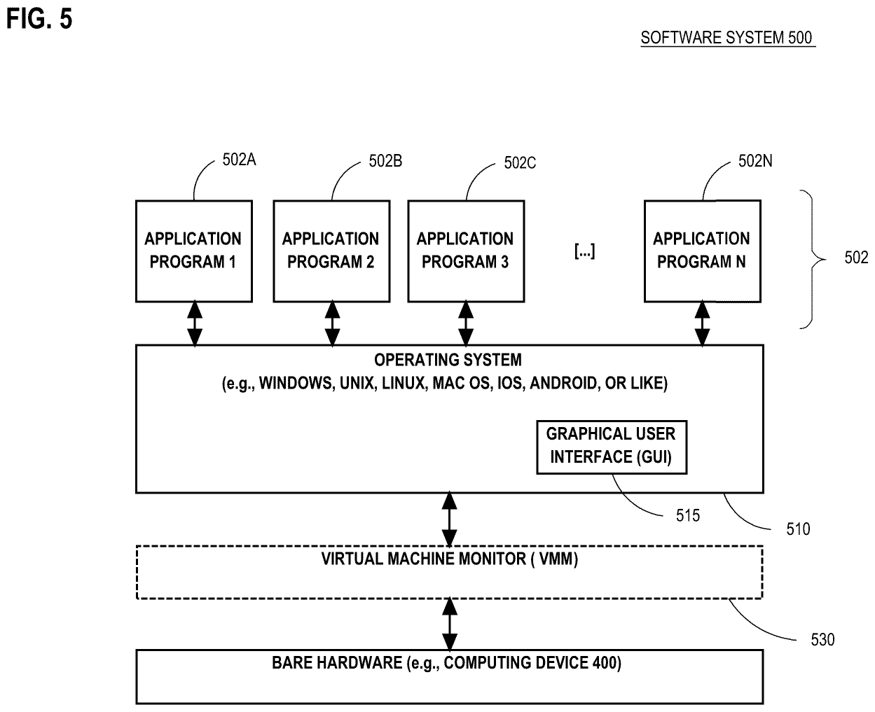

FIG. 5 is a block diagram of a basic software system 500 that may be employed for controlling the operation of computing system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 25; 2(1): 1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
detecting, by a large language model (LLM), for a technical requirement, an inaccuracy in a global explanation for a machine learning (ML) model;
generating, based on the inaccuracy, a linguistic prompt that contains the global explanation; and
generatively inferring, from the linguistic prompt, corrective natural language (NL) that describes how the global explanation is inaccurate.

2. The method of claim 1 further comprising multiplying a weight of the technical requirement by an inferred score that characterizes said detecting.

3. The method of claim 2 wherein:
said inaccuracy is a first inaccuracy;
said technical requirement is a first technical requirement;
said LLM is a first LLM;
the method further comprises:
detecting, by a second LLM, for a second technical requirement, a second inaccuracy in the global explanation for the ML model;
ordering, in the corrective NL, based on the inferred score, the first inaccuracy and the second inaccuracy.

4. The method of claim 2 further comprising based on an inferred score that characterizes a detection for a third technical requirement, deciding to exclude a third inaccuracy from the corrective NL.

5. The method of claim 1 wherein said generatively inferring comprises comparing an inferred confidence score to a threshold.

6. The method of claim 5 further comprising comparing the inferred confidence score to an inferred confidence score of a second global explanation for the ML model.

7. The method of claim 1 further comprising generatively inferring, from the corrective NL that describes how the global explanation is inaccurate, a revised global explanation for the ML model.

8. The method of claim 1 wherein the corrective NL that describes how the global explanation is inaccurate contains an importance score of a feature.

9. The method of claim 1 wherein the technical requirement is selected from a group consisting of: semantic incoherence, pragmatic incoherence, factual inconsistency, syntactic ambiguity, semantic ambiguity, semantic irrelevance, and verbosity.

10. A method comprising:
first detecting, by a first large language model (LLM), for a first technical requirement, a first inaccuracy in a global explanation for a machine learning (ML) model;
second detecting, by a second LLM, that the global explanation satisfies a second technical requirement;
generating, based on said first detecting and said second detecting, a linguistic prompt that contains the global explanation;
inferentially detecting, from the linguistic prompt, that the global explanation is accurate.

11. The method of claim 10 wherein:
said inferentially detecting comprises inferring from a plurality of numbers;
the plurality of numbers is selected from a group consisting of: a) in the linguistic prompt, a plurality of importance scores of features and b) not in the linguistic prompt, a plurality of weights of technical requirements.

12. The method of claim 10 further comprising adjusting a plurality of weights of technical requirements.

13. The method of claim 10 wherein the linguistic prompt contains a plural pronoun or a plurality of distinct pronouns.

14. One or more non-transitory computer-readable media storing instructions that, when executed by one or more processors, cause:
detecting, by a large language model (LLM), for a technical requirement, an inaccuracy in a global explanation for a machine learning (ML) model;
generating, based on the inaccuracy, a linguistic prompt that contains the global explanation;
generatively inferring, from the linguistic prompt, corrective natural language (NL) that describes how the global explanation is inaccurate.

15. The one or more non-transitory computer-readable media of claim 14 wherein said generatively inferring comprises comparing an inferred confidence score to a threshold.

16. The one or more non-transitory computer-readable media of claim 14 wherein the instructions further cause generatively inferring, from the corrective NL that describes how the global explanation is inaccurate, a revised global explanation for the ML model.

17. The one or more non-transitory computer-readable media of claim 14 wherein the technical requirement is selected from a group consisting of: semantic incoherence, pragmatic incoherence, factual inconsistency, syntactic ambiguity, semantic ambiguity, semantic irrelevance, and verbosity.

18. One or more non-transitory computer-readable media storing instructions that, when executed by one or more processors, cause:
first detecting, by a first large language model (LLM), for a first technical requirement, a first inaccuracy in a global explanation for a machine learning (ML) model;
second detecting, by a second LLM, that the global explanation satisfies a second technical requirement;
generating, based on said first detecting and said second detecting, a linguistic prompt that contains the global explanation; and
inferentially detecting, from the linguistic prompt, that the global explanation is accurate.

19. The one or more non-transitory computer-readable media of claim 18 wherein:
said inferentially detecting comprises inferring from a plurality of numbers;
the plurality of numbers is selected from a group consisting of: a) in the linguistic prompt, a plurality of importance scores of features and b) not in the linguistic prompt, a plurality of weights of technical requirements.

20. The one or more non-transitory computer-readable media of claim 18 wherein the instructions further cause adjusting a plurality of weights of technical requirements.
